(19) United States
(12) Patent Application Publication
(10) Pub. No.: US 2025/0199874 A1
(43) Pub. Date: Jun. 19, 2025

(54) RESOURCE SCHEDULING METHOD, ELECTRONIC DEVICE, AND STORAGE MEDIUM

(71) Applicant: Beijing Volcano Engine Technology Co., Ltd., Beijing (CN)

(72) Inventors: Keke CAO, Beijing (CN); Kehuai WANG, Beijing (CN); Jiewei YAN, Beijing (CN); Caihong LIU, Beijing (CN)

(21) Appl. No.: 18/782,871

(22) Filed: Jul. 24, 2024

(30) Foreign Application Priority Data
Dec. 14, 2023 (CN) 202311723782.7

(51) Int. Cl. G06F 9/50; G06F 9/455

(52) U.S. Cl. CPC G06F 9/5077; G06F 9/45558; G06F 2009/45562

(57) ABSTRACT

A resource scheduling method, electronic device, and computer-readable storage medium. The resource scheduling method includes: creating a scheduling interface object for performing resource preoccupation in response to a resource capacity adjustment instruction for an initial container group that has been created on a resource node, wherein the resource capacity adjustment instruction includes target resource capacity after adjustment; if it is determined that the resource capacity adjustment instruction is a resource capacity expansion instruction, creating a virtual container group on the resource node according to a capacity difference between the target resource capacity and an initial resource capacity of the initial container group; and controlling the scheduling interface object to perform preoccupation on a resource corresponding to the initial container group and a resource corresponding to the virtual container group, and creating a new container group based on all preoccupied resources of the scheduling interface object.

### CROSS-REFERENCE TO RELATED APPLICATION(S)

The present application claims priority of the Chinese Patent Applications No. 202311723782.7 filed on Dec. 14, 2023, the content of which is incorporated as a part of the present application.

### TECHNICAL FIELD

Embodiments of the present disclosure relate to the field of computer and network communications, and in particular, to a resource scheduling method and device, and a storage medium.

### BACKGROUND

In the field of container orchestration, container orchestration frameworks such as Kubernetes have strong container orchestration capabilities. A container group Pod is a basic carrier for resource allocation in a container orchestration framework, and binds to a corresponding resource requirement according to a service logic.

In a related technology, for a Pod that has been deployed on any resource node in the container orchestration framework, when capacity of the Pod needs to be expanded or reduced, resource preoccupation needs to be performed on idle resources of the resource node based on target resource capacity obtained after capacity expansion or capacity reduction is performed, and the preoccupied resources can be directly used when a new Pod on which capacity expansion or capacity reduction is performed is finally created.

However, when the resource node may have tight resources, or the target resource capacity obtained after capacity expansion or capacity reduction is performed is large, capacity expansion or capacity reduction may fail.

### SUMMARY

Embodiments of the present disclosure provide a resource scheduling method, an electronic device, and a storage medium, to prevent capacity expansion or capacity reduction of a deployed Pod from being limited by an idle resource capacity of a resource node, thereby ensuring success of capacity expansion or capacity reduction.

According to a first aspect, embodiments of the present disclosure provide a resource scheduling method, which includes:
creating a scheduling interface object for performing resource preoccupation in response to a resource capacity adjustment instruction for an initial container group that has been created on a resource node, wherein the resource capacity adjustment instruction includes target resource capacity after adjustment;
if it is determined that the resource capacity adjustment instruction is a resource capacity expansion instruction, creating a virtual container group on the resource node according to a capacity difference between the target resource capacity and an initial resource capacity of the initial container group; and
controlling the scheduling interface object to perform preoccupation on a resource corresponding to the initial container group and a resource corresponding to the virtual container group, and creating a new container group based on all preoccupied resources of the scheduling interface object.

According to a second aspect, embodiments of the present disclosure provide an electronic device, which includes:
at least one processor; and
a non-transitory memory with instructions thereon,
wherein upon the instructions being executed by the processor, the processor is configured for:
creating a scheduling interface object for performing resource preoccupation in response to a resource capacity adjustment instruction for an initial container group that has been created on a resource node, wherein the resource capacity adjustment instruction includes target resource capacity after adjustment;
if it is determined that the resource capacity adjustment instruction is a resource capacity expansion instruction, creating a virtual container group on the resource node according to a capacity difference between the target resource capacity and an initial resource capacity of the initial container group; and
controlling the scheduling interface object to perform preoccupation on a resource corresponding to the initial container group and a resource corresponding to the virtual container group, and creating a new container group based on all preoccupied resources of the scheduling interface object.

According to a third aspect, embodiments of the present disclosure provide a computer-readable storage medium, wherein the computer-readable storage medium stores computer-executable instructions, and upon a processor executing the computer-executable instructions, the resource scheduling method according to the first aspect is implemented.

### BRIEF DESCRIPTION OF DRAWINGS

In order to explain the embodiments of the present disclosure or the technical solution in the prior art more clearly, the drawings needed in the description of the embodiments or the prior art will be briefly introduced below. Obviously, the drawings in the following description are some embodiments of the present disclosure, and other drawings can be obtained according to these drawings for ordinary people in the field without paying creative labor.

FIG. 1a is an exemplary diagram of a scenario of a resource scheduling method according to an embodiment of the present disclosure;

FIG. 1b is an exemplary diagram of a scenario of a resource scheduling method according to another embodiment of the present disclosure;

FIG. 2 is a schematic flowchart of a resource scheduling method according to an embodiment of the present disclosure;

FIG. 3a is a schematic flowchart of a resource scheduling method according to another embodiment of the present disclosure;

FIG. 3b is a schematic flowchart of a resource scheduling method according to another embodiment of the present disclosure;

FIG. 4 is a structural block diagram of a resource scheduling device according to an embodiment of the present disclosure; and

FIG. 5 is a schematic diagram of a hardware structure of an electronic device according to an embodiment of the present disclosure.

### DETAILED DESCRIPTION

In order to make the purpose, technical solution and advantages of the embodiment of the disclosure clearer, the technical solution in the embodiment of the disclosure will be described clearly and completely with the attached drawings. Obviously, the described embodiment is a part of the embodiment of the disclosure, but not the whole embodiment. Based on the embodiments in this disclosure, all other embodiments obtained by ordinary technicians in this field without creative work belong to the scope of protection in this disclosure.

In the field of container orchestration, container orchestration frameworks such as Kubernetes have strong container orchestration capabilities. A container group Pod is a basic carrier for resource allocation in a container orchestration framework, and binds to a corresponding resource requirement according to a service logic. However, in an actual application process, we hope to allocate resources to some specific Pods and loads that have not been created, for example:
(1) preemption: an existing preemption rule cannot ensure that only a Pod currently in preemption can allocate preempted resources, and therefore a scheduler is expected to lock resources, to prevent these resources from being preempted by another Pod with a same or higher priority;
(2) rescheduling: in a rescheduling scenario, it is best to ensure that sufficient resources are reserved before the Pod is rescheduled; and otherwise, the rescheduled Pod may not be able to be scheduled back to an original node. This may cause some applications using a local disk of the node to be unable to run; and
(3) resource pre-allocation: even if a current resource is still unavailable, it is expected to reserve node resources for a future resource requirement.

However, conventional container orchestration frameworks such as Kubernetes cannot provide these capabilities.

In a related technology, for example, in an open-source Koordinator system, a concept of resource preoccupation is proposed, where a Koord-Scheduler provides a scheduling interface API named Reservation, which allows to reserve node resources for specific Pods and loads that have not been created. A thought for implementation is as follows:

First, a virtual container group Fake Pod is created, which has a same scheduling constraint condition as a specific Pod, to perform an actual scheduling operation. A Reservation object is created, to reserve a resource corresponding to the Fake Pod. When a user really needs to create the specific Pod, a resource matching operation is performed, to match the real specific Pod with the Reservation object. If matching succeeds, the specific Pod directly uses the resource that has been reserved by the Reservation object.

In this related technology, for a Pod that has been deployed on any resource node, when capacity of the Pod needs to be expanded or reduced, resource preoccupation needs to be implemented through the Reservation object on idle resources of the resource node based on target resource capacity obtained after capacity expansion or capacity reduction is performed, and the preoccupied resources can be directly used when a new Pod on which capacity expansion or capacity reduction is performed is finally created.

However, when the resource node may have tight resources, capacity expansion or capacity reduction may fail. For example, remaining idle resources of the resource node may be only 2C4G (2-core CPU and 4G memory), but the requirement is to expand one 4C8G Pod to 6C10G. In this case, the idle resources of the resource node are insufficient to perform 6C10G full resource preoccupation; or

when the target resource capacity obtained through capacity expansion or capacity reduction is large, or even the target resource capacity exceeds a half of total resources of the resource node, full resource preoccupation cannot be performed on the resource node before the initial Pod is destructed, and a failure of capacity expansion or capacity reduction is also caused. For example, the resource node has total resources of 128C256G, and the requirement in this case is to expand one Pod with a specification of 80C160G to 100C200G.

In the foregoing case, full resource preoccupation cannot be performed on idle resources of the resource node. However, if resources occupied by the initial Pod are first released, and then required full resources are preempted, the resources occupied by the initial Pod may be preempted by another Pod after being released. As a result, the specific Pod obtained through capacity expansion or capacity reduction may not be deployed on the resource node. This may further cause some applications using a local disk of the resource node to be unable to run.

To resolve the foregoing technical problem, the present disclosure provides a resource scheduling method, including: creating a scheduling interface object for performing resource preoccupation in response to a resource capacity adjustment instruction for an initial container group (Pod) that has been created on a resource node, where the resource capacity adjustment instruction includes target resource capacity after adjustment; if it is determined that the resource capacity adjustment instruction is a resource capacity expansion instruction, creating a virtual container group on the resource node according to a capacity difference between the target resource capacity and an initial resource capacity of the initial container group; and performing, by the scheduling interface object, preoccupation on a resource corresponding to the initial container group and a resource corresponding to the virtual container group, and creating a new container group based on all preoccupied resources of the scheduling interface object. When the resource capacity of the initial container group that has been created on the resource node is expanded, the virtual container group needs to be created only based on an incremental part, and the scheduling interface object preoccupies the resource corresponding to the virtual container group and also preoccupies the resource corresponding to the initial container group, so that the resource corresponding to the initial container group and the resource corresponding to the virtual container group are sufficient for creating the new container group after capacity expansion, to prevent capacity expansion from being limited by the idle resource capacity of the resource node, and ensure success of capacity expansion, thereby making resource management and scheduling more flexible and effective.

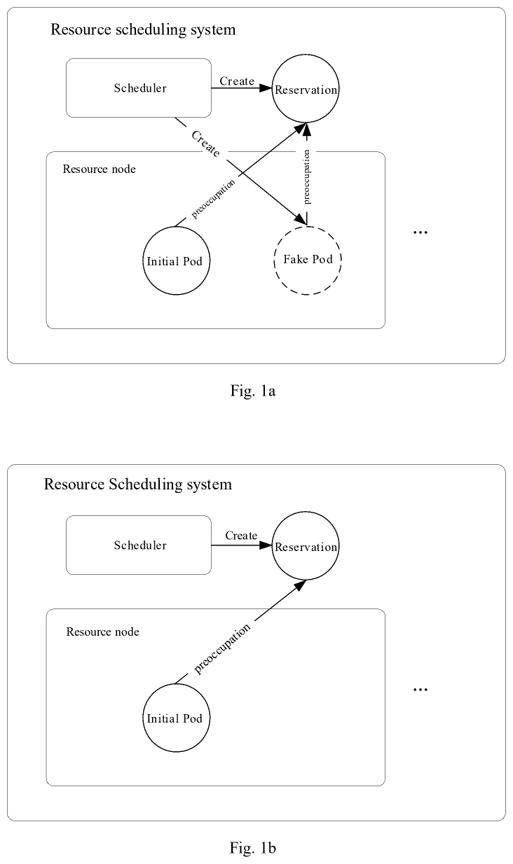

The resource scheduling method provided in the present disclosure is applicable to a scenario shown in FIG. 1a. In a resource scheduling system (such as the Kubernetes container orchestration system), when the resource capacity of the initial container group (an initial Pod) that has been created needs to be expanded, a scheduler (Scheduler) creates the scheduling interface object (Reservation) for performing resource preoccupation, and creates the virtual container group (a Fake Pod) on the resource node according to an incremental resource capacity that needs to be expanded (the capacity difference between the target resource capacity and the initial resource capacity); and the scheduling interface object (Reservation) preoccupies the resource corresponding to the initial container group (the initial Pod) and the resource corresponding to the virtual container group (the Fake Pod), and creates the new container group based on all the preoccupied resources of the scheduling interface object.

When the resource capacity of the initial container group (the initial Pod) that has been created needs to be reduced, as shown in FIG. 1b, the scheduler (Scheduler) creates the scheduling interface object (Reservation) for performing resource preoccupation. Because the initial resource capacity of the initial container group (the initial Pod) is sufficient for creating the new container group, the virtual container group (the Fake Pod) does not need to be created on the resource node, and only the scheduling interface object (Reservation) needs to preoccupy the resource corresponding to the initial container group (the initial Pod), and create the new container group based on all the preoccupied resources of the scheduling interface object.

Hereinafter, the resource scheduling method of the present disclosure will be described in detail with reference to specific embodiments.

FIG. 2 is a schematic flowchart of a resource scheduling method according to an embodiment of the present disclosure. The method in this embodiment may be used in a resource scheduling system (for example, the Kubernetes container orchestration system), and the resource scheduling method includes:

S201: creating a scheduling interface object for performing resource preoccupation in response to a resource capacity adjustment instruction for an initial container group that has been created on a resource node, where the resource capacity adjustment instruction includes target resource capacity after adjustment.

In this embodiment, in container orchestration frameworks such as Kubernetes, for a container group (Pod) that has been created on any resource node in a cluster, if a user needs to adjust resource capacity (for example, a CPU and a memory) of the container group, including resource capacity expansion or resource capacity reduction, the created container group may be used as the initial container group, and resource capacity obtained after adjustment is performed is the target resource capacity. If resource capacity expansion is performed, the target resource capacity is greater than the initial resource capacity of the initial container group (resource capacity of at least one of resources such as the CPU and the memory in the target resource capacity is greater than the corresponding initial resource capacity); or if resource capacity reduction is performed, the target resource capacity is less than the initial resource capacity of the initial container group (resource capacity of each of the resources such as the CPU and the memory in the target resource capacity is not greater than the corresponding initial resource capacity, and resource capacity of at least one of the resources is less than the corresponding initial resource capacity).

The user may send, to the resource scheduling system, the resource capacity adjustment instruction for the initial container group that has been created on the resource node. The resource capacity adjustment instruction may include but is not limited to the target resource capacity obtained through adjustment, and may certainly further include resource node information, initial container group information, and the like. The resource scheduling system may create, according to the resource capacity adjustment instruction, the scheduling interface object (Reservation) for performing resource preoccupation. The scheduling interface object may be similar to a Reservation API in an open-source Koordinator system, to preoccupy resources.

S202: if it is determined that the resource capacity adjustment instruction is a resource capacity expansion instruction, creating a virtual container group on the resource node according to a capacity difference between the target resource capacity and an initial resource capacity of the initial container group.

In this embodiment, for a resource capacity expansion scenario, considering that remaining resource capacity of the resource node may be insufficient for creating the virtual container group (Fake Pod) with the size of the target resource capacity, in this embodiment, it is considered that the resource corresponding to the initial container group (that is, the resource that has been occupied by the initial container group) may continue to be used (preoccupation is also required before recycling or after recycling) after being recycled, and the virtual container group for only an incremental part is created for an increment of the target resource capacity relative to the initial resource capacity for preoccupation.

During specific implement ion, a size of the increment, that is, the capacity difference between the target resource capacity and the initial resource capacity may be first determined, and then a virtual container group is created on the resource node based on the capacity difference, so that the resource capacity of the virtual container group is equal to the capacity difference. A process of creating the virtual container group (Fake Pod) may be performed in a scheduler of the resource scheduling system, and resources required by the virtual container group are reserved on the resource node, and are bound to the virtual container group. A specific process may be performed by using any known method, for example, a process of creating the virtual container group in the Koordinator system. This is not limited herein.

S203: controlling the scheduling interface object to perform preoccupation on a resource corresponding to the initial container group and a resource corresponding to the virtual container group, and creating a new container group based on all preoccupied resources of the scheduling interface object.

In this embodiment, because the scheduling interface object is created in the foregoing step S202, but the scheduling interface object that has been created just now does not specify resources that need to be preoccupied, the resource corresponding to the created virtual container group and the resource corresponding to the initial container group may be handed over to the scheduling interface object for preoccupation, so that resource capacity actually preoccupied by the scheduling interface object is equal to the target resource capacity, and the new container group can be subsequently created based on all the preoccupied resources of the scheduling interface object, so that the resource capacity of the new container group is equal to the target resource capacity, to implement capacity expansion on the initial container group.

In the resource scheduling method provided in this embodiment, the method includes: creating a scheduling interface object for performing resource preoccupation in response to a resource capacity adjustment instruction for an initial container group that has been created on a resource node, where the resource capacity adjustment instruction includes a target resource capacity after adjustment; if it is determined that the resource capacity adjustment instruction is a resource capacity expansion instruction, creating a virtual container group on the resource node according to a capacity difference between the target resource capacity and an initial resource capacity of the initial container group; and controlling the scheduling interface object to perform preoccupation on a resource corresponding to the initial container group and a resource corresponding to the virtual container group, and creating a new container group based on all preoccupied resources of the scheduling interface object. When the resource capacity of the initial container group that has been created on the resource node is expanded, the virtual container group needs to be created only based on an incremental part, and the scheduling interface object preoccupies the resource corresponding to the virtual container group and also preoccupies the resource corresponding to the initial container group, so that the resource corresponding to the initial container group and the resource corresponding to the virtual container group are sufficient for creating the new container group after capacity expansion, to prevent capacity expansion from being limited by the idle resource capacity of the resource node, and ensure success of capacity expansion, that is, ensure that the new container group can be restarted on the original resource node, thereby making resource management and scheduling more flexible and effective.

Based on any one of the foregoing embodiments, when controlling the scheduling interface object to perform preoccupation on a resource corresponding to the initial container group and a resource corresponding to the virtual container group in S203, the method may specifically include:
adding the resource corresponding to the virtual container group to preoccupied resources managed by the scheduling interface object for preoccupation; and
associating the initial container group with the scheduling interface object, and after the resource corresponding to the initial container group is recycled, adding the resource corresponding to the initial container group as recycled to the preoccupied resources managed by the scheduling interface object for preoccupation.

In this embodiment, the preoccupied resources managed by the scheduling interface object are incremental resources that need to be requested from the resource node for preoccupation. However, because the resource corresponding to the initial container group has not been recycled at the moment, the resource corresponding to the virtual container group needs to be first added to the preoccupied resources managed by the scheduling interface object (or in other words, resources that have been preoccupied or resources on which preoccupation succeeds), so that the resource corresponding to the virtual container group can be managed and scheduled by the scheduling interface object. Because the process of creating the virtual container group is equivalent to preoccupying the resource corresponding to the virtual container group, and when the resource corresponding to the virtual container group is added to the preoccupied resources managed by the scheduling interface object, it is specified that the resource corresponding to the virtual container group is preoccupied by the scheduling interface object.

However, for the resource corresponding to the initial container group, because the resource has not been recycled at the beginning, the initial container group may be first associated with the scheduling interface object, that is, the resource corresponding to the initial container group is first reserved, to prevent the resource corresponding to the initial container group from being preempted by anther scheduling interface object after being recycled; and after the resource corresponding to the initial container group is recycled, the resource corresponding to the initial container group as recycled is added to the preoccupied resources managed by the scheduling interface object, so that the resource corresponding to the initial container group can be managed and scheduled by the scheduling interface object, that is, it is specified that the resource corresponding to the initial container group is preoccupied by the scheduling interface object.

During specific implementation, after the initial container group is associated with the scheduling interface object, a deletion interceptor may be added to the initial container group. For example, a deletion interceptor Finalizer may be added to the initial container group, the Finalizer is actually a field, and when the initial container group in which the Finalizer field exists needs to be deleted, due to existence of the Finalizer field, the initial container group is not immediately deleted, and can only be deleted after the Finalizer field is removed. After it is detected that the initial container group exits, the resource corresponding to the initial container group is added to the preoccupied resources managed by the scheduling interface object for preoccupation, and then the deletion interceptor in the initial container group is removed, that is, the Finalizer field is removed. In this way, the initial container group can be deleted to recycle the resource corresponding to the initial container group. Because the resource corresponding to the initial container group as recycled has been pre-added to the preoccupied resources managed by the scheduling interface object, when the resource is recycled, actual preoccupation of the resource by the scheduling interface object is completed, to achieve a seamless transition effect. In this way, the resource corresponding to the initial container group can be prevented from be preempted by another scheduling interface object in a process of first being recycled and then being preoccupied.

Based on the foregoing embodiment, configuration information (for example, a spec field of an API configuration document) of the scheduling interface object (the Reservation API) used for performing resource preoccupation may include target resource capacity that needs to be preoccupied, and may further include preoccupied resource information (that is, resource capacity that has been preoccupied). Therefore, during specific implementation of adding the resource corresponding to the virtual container group to the preoccupied resources managed by the scheduling interface object for preoccupation, the preoccupied resource information is modified, in the configuration information of the scheduling interface object, as resource information of the resource corresponding to the virtual container group.

In addition, the configuration information of the scheduling interface object may further include to-be-recycled resource information. Therefore, during specific implementation of associating the initial container group with the scheduling interface object, the to-be-recycled resource information is modified, in the configuration information of the scheduling interface object, as resource information of the resource corresponding to the initial container group.

Further, during specific implementation of adding the resource corresponding to the initial container group to the preoccupied resources managed by the scheduling interface object after it is detected that the initial container group exits, the resource information that is of the resource corresponding to the initial container group and that is in the to-be-recycled resource information may be added, in the configuration information of the scheduling interface object, to the preoccupied resource information, and the to-be-recycled resource information is cleared.

The following provides description by using some content of the configuration information (for example, the spec field in the API configuration document) of a specific scheduling interface object (Reservation API) as an example. It is assumed that the initial resource capacity of the initial container group is cpu: 400 m, memory: 700 Mi, and the size of the target resource capacity is cpu: 500 m, memory: 800 Mi.

When the resource corresponding to the virtual container group is added to the preoccupied resources managed by the scheduling interface object for preoccupation, the preoccupied resource information (allocatable) is modified as the resource information (including cpu and memory capacity) of the resource corresponding to the virtual container group; and when the initial container group is associated with the scheduling interface object, the to-be-recycled resource information (toBeRecliam) is modified as the resource information (including cpu and memory capacity, and position information nodeName) of the resource corresponding to the initial container group; and in this case, some content of the configuration information of the scheduling interface object is as follows:

```
{ status:
allocatable:#used to represent preoccupied resource information
  cpu: 100m
  memory: 100Mi
toBeRecliam: #used to represent to-be-recycled resource information
  cpu: 400m
  memory: 700Mi
  nodeName: n180-016-028
phase: Waiting
}
```

After it is detected that the initial container group exits, the resource information of the resource that corresponds to the initial container group and that is in the to-be-recycled resource information is added to the preoccupied resource information, and the to-be-recycled resource information is cleared. In this case, some content of the configuration information of the scheduling interface object is as follows:

```
{ status:
allocatable:
  cpu: 500m
  memory: 800Mi
toBeRecliam:
cpu:
memory:
nodeName:
phase: Available
}
```

Based on any one of the foregoing embodiments, in a process in which the scheduling interface object preoccupies the resource corresponding to the initial container group and the resource corresponding to the virtual container group, the state of the scheduling interface object, for example, a phase field in the configuration information of the scheduling interface object in the foregoing example, may be updated according to states of the initial container group and the virtual container group. States of the scheduling interface object may include but are not limited to: a pending state, a failure state, a waiting state, and an available state.

During specific implementation, when the virtual container group is created on the resource node, if the virtual container group is not successfully created, the state of the scheduling interface object is updated to the pending state, and the reason for the failure to creation may be that the idle resource capacity on the current resource node is insufficient to create the virtual container group. Therefore, the state of the scheduling interface object is updated to the pending state at the moment, and one or more retries may be performed within a preset time, waiting for the resource node to recycle resources in subsequent processes to increase the idle resource capacity.

If the virtual container group is still not successfully created within the preset time after one or more retries, the state of the scheduling interface object is updated to the failure state, that is, retries are stopped, and an error may be reported to the user.

After the resource corresponding to the virtual container group is added to preoccupied resources managed by the scheduling interface object for preoccupation, and after the initial container group is associated with the scheduling interface object, the state of the scheduling interface object is updated to the waiting state. In this case, the waiting state is actually a state of waiting for recycling of the resource corresponding to the initial container group.

After the resource corresponding to the initial container group as recycled is added to the preoccupied resources managed by the scheduling interface object for preoccupation after it is detected that the initial container group exits, the state of the scheduling interface object is updated to the available state, that is, it indicates that the scheduling interface object completes full preoccupation of the target resource capacity.

After it is detected that the state of the scheduling interface object is the available state, the new container group may be created based on all the preoccupied resources of the scheduling interface object, to complete capacity expansion on the initial container group.

The foregoing process implements preoccupation of only the resource corresponding to the virtual container group when the resource corresponding to the initial container group is not recycled, that is, the incremental resource preoccupation, which is converted into preoccupation of the resource corresponding to the virtual container group and the resource corresponding to the initial container group as recycled after the resource corresponding to the initial container group is recycled, that is, full resource preoccupation, and this provides more flexible and effective solutions for resource management.

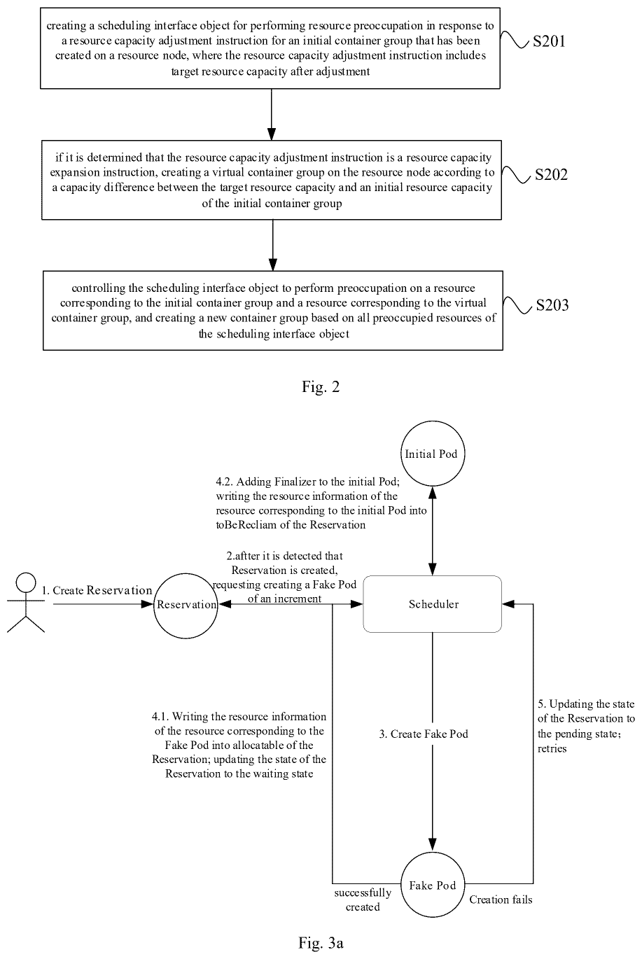

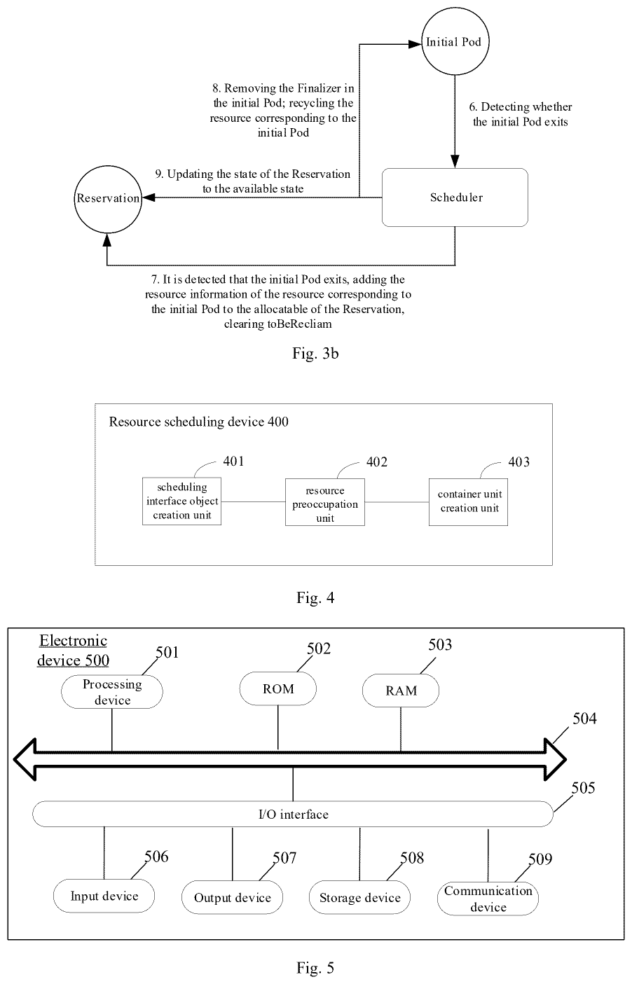

Based on any one of the foregoing embodiments, this embodiment provides a specific example of a resource scheduling method. As shown in FIG. 3a and FIG. 3b, in a scenario in which resource capacity expansion is performed on the initial container group, the resource scheduling method in this embodiment specifically includes:
(1) creating a scheduling interface object Reservation for performing resource preoccupation in response to a resource capacity adjustment instruction for an initial container group (an initial Pod) that has been created on a resource node;
(2) after it is detected that the Reservation is created, requesting a scheduler Scheduler in a resource scheduling system to create a virtual container group, that is, create a Fake Pod of an increment, on the resource node according to a capacity difference between target resource capacity and initial resource capacity of the initial container group;
(3) creating the Fake Pod by the scheduler Scheduler; and
if the Fake Pod is successfully created, performing step (4); or if creation of the Fake Pod fails, performing step (5);
(4) if the Fake Pod is successfully created, writing the resource information of the resource corresponding to the Fake Pod into the preoccupied resource information field (allocatable) in the configuration information of the Reservation; adding the deletion interceptor Finalizer to the initial Pod, and writing the resource information of the resource corresponding to the initial Pod into the to-be-recycled resource information field (toBeRecliam) in the configuration information of the Reservation; and updating the state of the Reservation to the waiting state;
(5) if creation of the Fake Pod fails, updating the state of the Reservation to the pending state by the scheduler, and performing retries by the Scheduler; if the Fake Pod is still not successfully created when the preset time expires after the Scheduler performs a plurality of retries, updating the state of the Reservation to the failure state;
(6) detecting whether the initial Pod exits;
(7) after it is detected that the initial Pod (including all containers) exits, adding the resource information of the resource corresponding to the initial Pod to the preoccupied resource information field (allocatable) in the configuration information of the Reservation, and clearing the resource information that is of the resource corresponding to the initial Pod and that is in the to-be-recycled resource information field (toBeRecliam);
(8) removing the deletion interceptor Finalizer from the initial Pod; and deleting the initial Pod, and recycling the resource corresponding to the initial Pod; and
(9) updating the state of the Reservation to the available state.

In another embodiment, in the resource capacity reduction scenario, the resource capacity adjustment instruction is the resource capacity reduction instruction, and after the foregoing S201, the method further includes:
if it is determined that the resource capacity adjustment instruction is a resource capacity reduction instruction, controlling the scheduling interface object to perform preoccupation on the resource corresponding to the initial container group, and creating the new container group based on all the preoccupied resources of the scheduling interface object.

In this embodiment, when resource capacity reduction needs to be performed on the initial container group, because the target resource capacity obtained through reduction is less than the initial resource capacity of the initial container group (resource capacity of each of the resources such as the CPU and the memory in the target resource capacity is not greater than the corresponding initial resource capacity, and resource capacity of at least one of the resources is less than the corresponding initial resource capacity), only the resource corresponding to the initial container group needs to be preoccupied to obtain sufficient target resource capacity with a surplus, and no additional resources need to be preoccupied, that is, there is no need to create an incremental virtual container group.

Therefore, a difference between the resource scheduling method in the resource capacity reduction scenario is different from the resource scheduling method in resource capacity expansion is that, there is no need to create the virtual container group, and there is no need to execute the foregoing process related to the virtual container group, and other processes related to the initial container group may be the same. A specific process is as follows:

In an embodiment, the controlling the scheduling interface object to perform preoccupation on the resource corresponding to the initial container group may specifically include:
associating the initial container group with the scheduling interface object, and after the resource corresponding to the initial container group is recycled, adding the resource corresponding to the initial container group as recycled to the preoccupied resources managed by the scheduling interface object for preoccupation.

In this embodiment, because the resource corresponding to the initial container group has not been recycled at the beginning, the initial container group may be first associated with the scheduling interface object, that is, the resource corresponding to the initial container group is first reserved, to prevent the resource corresponding to the initial container group from being preempted by anther scheduling interface object after being recycled; and after the resource corresponding to the initial container group is recycled, the resource corresponding to the initial container group as recycled is added to the preoccupied resources managed by the scheduling interface object, so that the resource corresponding to the initial container group can be managed and scheduled by the scheduling interface object, that is, it is specified that the resource corresponding to the initial container group is preoccupied by the scheduling interface object.

During specific implementation, after the initial container group is associated with the scheduling interface object, a deletion interceptor may be added to the initial container group. For example, a deletion interceptor Finalizer may be added to the initial container group, the Finalizer is actually a field, and when the initial container group in which the Finalizer field exists needs to be deleted, due to existence of the Finalizer field, the initial container group is not immediately deleted, but is called back, and can only be deleted after the Finalizer field is removed, so that another scheduling interface object can be prevented from deleting the initial container group. After it is detected that the initial container group exits, the initial container group needs to be deleted. Due to existence of the Finalizer, callback is performed, and the resource corresponding to the initial container group is added to the preoccupied resources managed by the scheduling interface object for preoccupation, and then the deletion interceptor in the initial container group is removed, that is, the Finalizer field is removed. In this way, the initial container group can be deleted to recycle the resource corresponding to the initial container group. Because the resource corresponding to the initial container group as recycled has been pre-added to the preoccupied resources managed by the scheduling interface object, when the resource is recycled, actual preoccupation of the resource by the scheduling interface object is completed, to achieve a seamless transition effect. In this way, the resource corresponding to the initial container group can be prevented from be preempted by another scheduling interface object in a process of first being recycled and then being preoccupied.

Based on the foregoing embodiment, configuration information (for example, a spec field of an API configuration document) of the scheduling interface object (the Reservation API) used for performing resource preoccupation may include target resource capacity that needs to be preoccupied, and may further include preoccupied resource information (that is, resource capacity that has been preoccupied). Because the virtual container group does not exist, the preoccupied resource information may be empty.

The configuration information of the scheduling interface object may further include to-be-recycled resource information. Therefore, during specific implementation of associating the initial container group with the scheduling interface object, the to-be-recycled resource information is modified, in the configuration information of the scheduling interface object, as resource information of the resource corresponding to the initial container group.

Further, during specific implementation of adding the resource corresponding to the initial container group to the preoccupied resources managed by the scheduling interface object after it is detected that the initial container group exits, the resource information that is of the resource corresponding to the initial container group and that is in the to-be-recycled resource information may be added, in the configuration information of the scheduling interface object, to the preoccupied resource information, and the to-be-recycled resource information is cleared.

The following provides description by using some content of the configuration information (for example, the spec field in the API configuration document) of a specific scheduling interface object (Reservation API) as an example. It is assumed that the initial resource capacity of the initial container group is cpu: 400 m, memory: 700 Mi, and the size of the target resource capacity is cpu: 300 m, memory: 500 Mi.

When the initial container group is associated with the scheduling interface object, the to-be-recycled resource information (toBeRecliam) is modified as the resource information (including cpu and memory capacity, and position information nodeName) of the resource corresponding to the initial container group. Because there is no need to create the virtual container group, the preoccupied resource information (allocatable) is empty, and in this case, some content of the configuration information of the scheduling interface object is as follows:

```
{ status:
  allocatable:
      cpu:
      memory:
  toBeRecliam:
      cpu: 400m
      memory: 700Mi
      nodeName: n180-016-028
    phase: Waiting
}
```

After it is detected that the initial container group exits, the resource information of the resource that corresponds to the initial container group and that is in the to-be-recycled resource information is added to the preoccupied resource information, and the to-be-recycled resource information is cleared. In this case, some content of the configuration information of the scheduling interface object is as follows:

```
{ status:
  allocatable:
    cpu: 400m
    memory: 700Mi
  toBeRecliam:
    cpu:
    memory:
    nodeName:
  phase: Available
}
```

Optionally, when the resource information that is of the resource corresponding to the initial container group and that is in the to-be-recycled resource information is added to the preoccupied resource information, some resource information of the resource corresponding to the initial container group may alternatively be added to the preoccupied resource information according to the target resource capacity, that is, the scheduling interface object only preoccupies resources with the size required by the target resource capacity, and in this case, some content of the configuration information of the scheduling interface object is as follows:

```
{ status:
  allocatable:
      cpu: 300m
      memory: 500Mi
  toBeRecliam:
      cpu:
      memory:
      nodeName:
    phase: Available
}
```

Based on any one of the foregoing embodiments, in a process in which the scheduling interface object preoccupies the resource corresponding to the initial container group, the state of the scheduling interface object, for example, the phase field in the configuration information of the scheduling interface object in the foregoing example, may also be updated according to the state of the initial container group. States of the scheduling interface object may include but are not limited to: a waiting state and an available state.

During specific implementation, after the initial container group is associated with the scheduling interface object, the state of the scheduling interface object is updated to the waiting state, and the waiting state in this case is actually a state of waiting for recycling of the resource corresponding to the initial container group.

After the resource corresponding to the initial container group as recycled is added to the preoccupied resources managed by the scheduling interface object for preoccupation after it is detected that the initial container group exits, the state of the scheduling interface object is updated to the available state, that is, it indicates that the scheduling interface object completes preoccupation of the target resource capacity.

After it is detected that the state of the scheduling interface object is the available state, the new container group may be created based on all the preoccupied resources of the scheduling interface object, to complete capacity expansion on the initial container group.

In the foregoing embodiments of the resource scheduling methods in the resource capacity reduction scenario, when the resource capacity of the initial container group that has been created on the resource node is reduced, the scheduling interface object only needs to preoccupy the resource corresponding to the initial container group, and the resource corresponding to the initial container group is sufficient for creating the new container group after capacity reduction, to prevent capacity reduction from being limited by the idle resource capacity of the resource node, and ensure success of capacity reduction, that is, ensure that the new container group after capacity reduction can be restarted on the original resource node, thereby making resource management and scheduling more flexible and effective.

Based on any one of the foregoing embodiments, the configuration information of the scheduling interface object may further include a preoccupation policy field, used to identify whether the scheduling interface object uses full resource preoccupation or non-full resource preoccupation. If non-full resource preoccupation is used, the resource scheduling methods (including resource scheduling methods in the resource capacity expansion scenario and the resource capacity reduction scenario) in the foregoing embodiments are performed; or if full resource preoccupation is used, a virtual container group needs to be created based on idle resources of the resource node, so that the resource capacity of the virtual container group is equal to the target resource capacity, and the resource corresponding to the virtual container group is added to the preoccupied resources managed by the scheduling interface object for preoccupation, and the new container group is subsequently directly created on the virtual container group. Whether to specifically use the full resource preoccupation or non-full resource preoccupation may be determined according to the idle resource capacity of the resource node and the size of the target resource capacity. If the idle resource capacity is not less than the target resource capacity, full resource preoccupation may be used; and otherwise, non-full resource preoccupation is used; and certainly, non-full resource preoccupation may be used in all cases.

Corresponding to the resource scheduling method in the foregoing embodiment, FIG. 4 is a structural block diagram of a resource scheduling device according to an embodiment of the present disclosure. For ease of description, only the part related to embodiments of the present disclosure is shown. With reference to FIG. 4, the resource scheduling device 400 includes: a scheduling interface object creation unit 401, a resource preoccupation unit 402, and a container unit creation unit 403.

The scheduling interface object creation unit is configured to create a scheduling interface object for performing resource preoccupation in response to a resource capacity adjustment instruction for an initial container group that has been created on a resource node, where the resource capacity adjustment instruction includes target resource capacity after adjustment;
the resource preoccupation unit is configured to: if it is determined that the resource capacity adjustment instruction is a resource capacity expansion instruction, create a virtual container group on the resource node according to a capacity difference between the target resource capacity and an initial resource capacity of the initial container group; and control the scheduling interface object to perform preoccupation on a resource corresponding to the initial container group and a resource corresponding to the virtual container group; and
the container group creation unit is configured to create a new container group based on all preoccupied resources of the scheduling interface object.

In one or more embodiments of the present disclosure, when controlling the scheduling interface object to perform preoccupation on a resource corresponding to the initial container group and a resource corresponding to the virtual container group, the resource preoccupation unit is configured to:
add the resource corresponding to the virtual container group to preoccupied resources managed by the scheduling interface object for preoccupation; and
associate the initial container group with the scheduling interface object, and after the resource corresponding to the initial container group is recycled, add the resource corresponding to the initial container group as recycled to the preoccupied resources managed by the scheduling interface object for preoccupation.

In one or more embodiments of the present disclosure, in the process of controlling the scheduling interface object to perform preoccupation on a resource corresponding to the initial container group and a resource corresponding to the virtual container group, the resource preoccupation unit is further configured to:
update a state of the scheduling interface object according to states of the initial container group and the virtual container group; and
correspondingly, when creating a new container group based on all preoccupied resources of the scheduling interface object, the container group creation unit is configured to:
after it is detected that the state of the scheduling interface object is an available state, create the new container group based on all the preoccupied resources of the scheduling interface object.

In one or more embodiments of the present disclosure, when updating a state of the scheduling interface object according to states of the initial container group and the virtual container group, the resource preoccupation unit is configured to:
add the resource corresponding to the virtual container group to preoccupied resources managed by the scheduling interface object for preoccupation, and update the state of the scheduling interface object to a waiting state after the initial container group is associated with the scheduling interface object; and
after the resource corresponding to the initial container group as recycled is added to the preoccupied resources managed by the scheduling interface object for preoccupation, update the state of the scheduling interface object to the available state.

In one or more embodiments of the present disclosure, when updating a state of the scheduling interface object according to states of the initial container group and the virtual container group, the resource preoccupation unit is configured to:
when the virtual container group is created on the resource node, if the virtual container group is not successfully created, update the state of the scheduling interface object to a pending state, and perform one or more retries within a preset time; and
if the virtual container group is not successfully created within the preset time, update the state of the scheduling interface object to a failure state.

In one or more embodiments of the present disclosure, after associating the initial container group with the scheduling interface object, the resource preoccupation unit is further configured to:
add a deletion interceptor to the initial container group; and
correspondingly, the adding the resource corresponding to the initial container group as recycled to the preoccupied resources managed by the scheduling interface object for preoccupation after the resource corresponding to the initial container group is recycled includes:
after it is detected that the initial container group exits, adding the resource corresponding to the initial container group to the preoccupied resources managed by the scheduling interface object; and
removing the deletion interceptor from the initial container group, and recycling the resource corresponding to the initial container group, to complete preoccupation of the resource corresponding to the initial container group as recycled by the scheduling interface object.

In one or more embodiments of the present disclosure, when adding the resource corresponding to the virtual container group to preoccupied resources managed by the scheduling interface object for preoccupation, the resource preoccupation unit is configured to:
modify preoccupied resource information in configuration information of the scheduling interface object as resource information of the resource corresponding to the virtual container group; and
when associating the initial container group with the scheduling interface object, the resource preoccupation unit is configured to:
modify, in configuration information of the scheduling interface object, to-be-recycled resource information as resource information of the resource corresponding to the initial container group; and
when adding the resource corresponding to the initial container group to the preoccupied resources managed by the scheduling interface object after it is detected that the initial container group exits, the resource preoccupation unit is configured to:
add, in the configuration information of the scheduling interface object, the resource information that is of the resource corresponding to the initial container group and that is in the to-be-recycled resource information to the preoccupied resource information, and clear the to-be-recycled information.

In one or more embodiments of the present disclosure, the resource preoccupation unit is configured to: if it is determined that the resource capacity adjustment instruction is a resource capacity reduction instruction, control the scheduling interface object to perform preoccupation on the resource corresponding to the initial container group, and
the container unit creation unit is further configured to create the new container group based on all the preoccupied resources of the scheduling interface object.

In one or more embodiments of the present disclosure, when controlling the scheduling interface object to perform preoccupation on the resource corresponding to the initial container group, the resource preoccupation unit is configured to:
associate the initial container group with the scheduling interface object, and after the resource corresponding to the initial container group is recycled, add the resource corresponding to the initial container group as recycled to the preoccupied resources managed by the scheduling interface object for preoccupation.

In one or more embodiments of the present disclosure, when controlling the scheduling interface object to perform preoccupation on the resource corresponding to the initial container group, the resource preoccupation unit is further configured to:
update a state of the scheduling interface object according to a state of the initial container group; and
correspondingly, when creating a new container group based on all preoccupied resources of the scheduling interface object, the container group creation unit is configured to:
after it is detected that the state of the scheduling interface object is an available state, create the new container group based on all the preoccupied resources of the scheduling interface object.

In one or more embodiments of the present disclosure, when updating a state of the scheduling interface object according to a state of the initial container group, the resource preoccupation unit is configured to:
after the initial container group is associated with the scheduling interface object, update the state of the scheduling interface object to a waiting state; and
after the resource corresponding to the initial container group as recycled is added to the preoccupied resources managed by the scheduling interface object for preoccupation, update the state of the scheduling interface object to the available state.

In one or more embodiments of the present disclosure, after associating the initial container group with the scheduling interface object, the resource preoccupation unit is further configured to:
add a deletion interceptor to the initial container group; and
correspondingly, the adding the resource corresponding to the initial container group as recycled to the preoccupied resources managed by the scheduling interface object for preoccupation after the resource corresponding to the initial container group is recycled includes:
after it is detected that the initial container group exits, adding the resource corresponding to the initial container group to the preoccupied resources managed by the scheduling interface object; and
removing the deletion interceptor from the initial container group, and recycling the resource corresponding to the initial container group, to complete preoccupation of the resource corresponding to the initial container group as recycled by the scheduling interface object.

In one or more embodiments of the present disclosure, when associating the initial container group with the scheduling interface object, the resource preoccupation unit is configured to:
modify, in configuration information of the scheduling interface object, to-be-recycled resource information as resource information of the resource corresponding to the initial container group; and
the adding the resource corresponding to the initial container group to the preoccupied resources managed by the scheduling interface object after it is detected that the initial container group exits includes:
adding, in the configuration information of the scheduling interface object, the resource information that is of the resource corresponding to the initial container group and that is in the to-be-recycled resource information to the preoccupied resource information, and clearing the to-be-recycled information.

The device provided in this embodiment may be configured to execute the technical solutions in the foregoing method embodiments, and an implementation principle and technical effect of the device are similar to those of the method embodiments, and details are not described herein again in this embodiment.

Referring to FIG. 5, it shows a structural schematic diagram of an electronic device 500 suitable for implementing the embodiment of the present disclosure, which may be a terminal device or a server. The terminal equipment may include, but is not limited to, mobile terminals such as mobile phones, notebook computers, digital broadcast receivers, personal digital assistant (PDA), portable android device (PAD), portable multimedia players (PMP), vehicle-mounted terminals (such as vehicle-mounted navigation terminals) and fixed terminals such as digital TVs and desktop computers. The electronic device shown in FIG. 5 is only an example, and should not bring any limitation to the function and application scope of the embodiment of the present disclosure.

As shown in FIG. 5, an electronic device 500 may include a processing device (such as a central processing unit, a graphics processor, etc.) 501, which may perform various appropriate actions and processes according to a program stored in a read only memory (ROM) 502 or a program loaded from a storage device 508 into a random access memory (RAM) 503. In the RAM 503, various programs and data required for the operation of the electronic device 500 are also stored. A processing device 501, a ROM 502 and a RAM 503 are connected to each other through a bus 504. An input/output (I/O) interface 505 is also connected to the bus 504.

Generally, the following devices can be connected to the I/O interface 505: an input device 506 including, for example, a touch screen, a touch pad, a keyboard, a mouse, a camera, a microphone, an accelerometer, a gyroscope, etc.; an output device 507 such as a liquid crystal display (LCD), a speaker, a vibrator, etc. Includes a storage device 508 such as a magnetic tape, a hard disk, etc.; and a communication device 509. The communication device 509 may allow the electronic device 500 to communicate wirelessly or wired with other devices to exchange data. Although FIG. 5 shows an electronic device 500 with various devices, it should be understood that it is not required to implement or have all the devices shown. More or fewer devices may alternatively be implemented or provided.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program can be downloaded and installed from the network through the communication device 509, or installed from the storage device 508 or from the ROM 502. When the computer program is executed by the processing device 501, the above functions defined in the method of the embodiment of the present disclosure are performed.

It should be noted that the computer-readable medium mentioned above in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or device, or a combination of any of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this disclosure, a computer-readable storage medium can be any tangible medium containing or storing a program, which can be used by or in combination with an instruction execution system, apparatus or device. In this disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, including but not limited to: wires, optical cables, RF (radio frequency) and the like, or any suitable combination of the above.

The computer-readable medium may be included in the electronic device; Or it can exist alone without being assembled into the electronic equipment.

The computer-readable medium carries one or more programs, which, when executed by the electronic device, cause the electronic device to perform the method shown in the above embodiments.

Computer program codes for performing the operations of the present disclosure may be written in one or more programming languages or combinations thereof, including object-oriented programming languages such as Java, Smalltalk, C++, and conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case of involving a remote computer, the remote computer can be connected to a user computer through any kind of network, including a Local Area Network (LAN) or a Wide Area Network (WAN), or can be connected to an external computer (for example, by using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. Among them, the name of the unit does not constitute the limitation of the unit itself in some cases. For example, the first acquisition unit can also be described as “the unit that acquires at least two Internet protocol addresses”.

The functions described above herein may be at least partially performed by one or more hardware logic components. For example, without limitation, exemplary types of hardware logic components that can be used include: field programmable gate array (FPGA), application specific integrated circuit (ASIC), application specific standard product (ASSP), system on chip (SOC), complex programmable logic device (CPLD) and so on.

In the context of this disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any suitable combination of the above.

According to a first aspect, at least one embodiment of the present disclosure provides a resource scheduling method, which includes:
creating a scheduling interface object for performing resource preoccupation in response to a resource capacity adjustment instruction for an initial container group that has been created on a resource node, wherein the resource capacity adjustment instruction includes target resource capacity after adjustment;
if it is determined that the resource capacity adjustment instruction is a resource capacity expansion instruction, creating a virtual container group on the resource node according to a capacity difference between the target resource capacity and an initial resource capacity of the initial container group; and
controlling the scheduling interface object to perform preoccupation on a resource corresponding to the initial container group and a resource corresponding to the virtual container group, and creating a new container group based on all preoccupied resources of the scheduling interface object.

According to at least one embodiment of the present disclosure, the controlling the scheduling interface object to perform preoccupation on a resource corresponding to the initial container group and a resource corresponding to the virtual container group includes:
adding the resource corresponding to the virtual container group to preoccupied resources managed by the scheduling interface object for preoccupation; and
associating the initial container group with the scheduling interface object, and after the resource corresponding to the initial container group is recycled, adding the resource corresponding to the initial container group as recycled to the preoccupied resources managed by the scheduling interface object for preoccupation.

According to at least one embodiment of the present disclosure, the controlling the scheduling interface object to perform preoccupation on a resource corresponding to the initial container group and a resource corresponding to the virtual container group further includes:
updating a state of the scheduling interface object according to states of the initial container group and the virtual container group; and
correspondingly, the creating a new container group based on all preoccupied resources of the scheduling interface object includes:
after it is detected that the state of the scheduling interface object is an available state, creating the new container group based on all the preoccupied resources of the scheduling interface object.

According to at least one embodiment of the present disclosure, the updating a state of the scheduling interface object according to states of the initial container group and the virtual container group includes:
adding the resource corresponding to the virtual container group to preoccupied resources managed by the scheduling interface object for preoccupation, and updating the state of the scheduling interface object to a waiting state after the initial container group is associated with the scheduling interface object; and
after the resource corresponding to the initial container group as recycled is added to the preoccupied resources managed by the scheduling interface object for preoccupation, updating the state of the scheduling interface object to the available state.

According to at least one embodiment of the present disclosure, the updating a state of the scheduling interface object according to states of the initial container group and the virtual container group includes:
when the virtual container group is created on the resource node, if the virtual container group is not successfully created, updating the state of the scheduling interface object to a pending state, and performing one or more retries within a preset time; and
if the virtual container group is not successfully created within the preset time, updating the state of the scheduling interface object to a failure state.

According to at least one embodiment of the present disclosure, after associating the initial container group with the scheduling interface object, the method further includes:
adding a deletion interceptor to the initial container group; and
correspondingly, the adding the recycled resource corresponding to the initial container group as recycled to the preoccupied resources managed by the scheduling interface object for preoccupation after the resource corresponding to the initial container group is recycled includes:
after it is detected that the initial container group exits, adding the resource corresponding to the initial container group to the preoccupied resources managed by the scheduling interface object; and
removing the deletion interceptor from the initial container group, and recycling the resource corresponding to the initial container group, to complete preoccupation of the recycled resource corresponding to the initial container group as recycled by the scheduling interface object.

According to at least one embodiment of the present disclosure, the adding the resource corresponding to the virtual container group to preoccupied resources managed by the scheduling interface object for preoccupation includes:
modifying preoccupied resource information in configuration information of the scheduling interface object as resource information of the resource corresponding to the virtual container group;
the associating the initial container group with the scheduling interface object includes:
modifying, in configuration information of the scheduling interface object, to-be-recycled resource information as resource information of the resource corresponding to the initial container group; and
the adding the resource corresponding to the initial container group to the preoccupied resources managed by the scheduling interface object after it is detected that the initial container group exits includes:
adding, in the configuration information of the scheduling interface object, the resource information that is of the resource corresponding to the initial container group and that is in the to-be-recycled resource information to the preoccupied resource information, and clearing the to-be-recycled information.

According to at least one embodiment of the present disclosure, the method further includes:
if it is determined that the resource capacity adjustment instruction is a resource capacity reduction instruction, controlling the scheduling interface object to perform preoccupation on the resource corresponding to the initial container group, and creating the new container group based on all the preoccupied resources of the scheduling interface object.

According to at least one embodiment of the present disclosure, the controlling the scheduling interface object to perform preoccupation on the resource corresponding to the initial container group includes:
associating the initial container group with the scheduling interface object, and after the resource corresponding to the initial container group is recycled, adding the resource corresponding to the initial container group as recycled to the preoccupied resources managed by the scheduling interface object for preoccupation.

According to at least one embodiment of the present disclosure, the controlling the scheduling interface object to perform preoccupation on the resource corresponding to the initial container group further includes:
updating a state of the scheduling interface object according to a state of the initial container group; and
correspondingly, the creating the new container group based on all the preoccupied resources of the scheduling interface object includes:
after it is detected that the state of the scheduling interface object is an available state, creating the new container group based on all the preoccupied resources of the scheduling interface object.

According to at least one embodiment of the present disclosure, the updating a state of the scheduling interface object according to a state of the initial container group includes:
after the initial container group is associated with the scheduling interface object, updating the state of the scheduling interface object to a waiting state; and
after the resource corresponding to the initial container group as recycled is added to the preoccupied resources managed by the scheduling interface object for preoccupation, updating the state of the scheduling interface object to the available state.

According to at least one embodiment of the present disclosure, after the associating the initial container group with the scheduling interface object, the method further includes:
adding a deletion interceptor to the initial container group; and
correspondingly, the adding the resource corresponding to the initial container group as recycled to the preoccupied resources managed by the scheduling interface object for preoccupation after the resource corresponding to the initial container group is recycled includes:
after it is detected that the initial container group exits, adding the resource corresponding to the initial container group to the preoccupied resources managed by the scheduling interface object; and
removing the deletion interceptor from the initial container group, and recycling the resource corresponding to the initial container group, to complete preoccupation of the resource corresponding to the initial container group as recycled by the scheduling interface object.

According to at least one embodiment of the present disclosure, the associating the initial container group with the scheduling interface object includes:
modifying, in configuration information of the scheduling interface object, to-be-recycled resource information as resource information of the resource corresponding to the initial container group; and
the adding the resource corresponding to the initial container group to the preoccupied resources managed by the scheduling interface object after it is detected that the initial container group exits includes:
adding, in the configuration information of the scheduling interface object, the resource information that is of the resource corresponding to the initial container group and that is in the to-be-recycled resource information to the preoccupied resource information, and clearing the to-be-recycled information.

According to a second aspect, at least one embodiment of the present disclosure provides a resource scheduling device, including:
a scheduling interface object creation unit, configured to create a scheduling interface object for performing resource preoccupation in response to a resource capacity adjustment instruction for an initial container group that has been created on a resource node, wherein the resource capacity adjustment instruction includes target resource capacity after adjustment;
a resource preoccupation unit, configured to: if it is determined that the resource capacity adjustment instruction is a resource capacity expansion instruction, create a virtual container group on the resource node according to a capacity difference between the target resource capacity and an initial resource capacity of the initial container group; and control the scheduling interface object to perform preoccupation on a resource corresponding to the initial container group and a resource corresponding to the virtual container group; and
a container group creation unit, configured to: create a new container group based on all preoccupied resources of the scheduling interface object.

According to at least one embodiment of the present disclosure, upon controlling the scheduling interface object to perform preoccupation on a resource corresponding to the initial container group and a resource corresponding to the virtual container group, the resource preoccupation unit is configured for:
adding the resource corresponding to the virtual container group to preoccupied resources managed by the scheduling interface object for preoccupation; and
associating the initial container group with the scheduling interface object, and after the resource corresponding to the initial container group is recycled, adding the resource corresponding to the initial container group as recycled to the preoccupied resources managed by the scheduling interface object for preoccupation.

According to at least one embodiment of the present disclosure, upon controlling the scheduling interface object to perform preoccupation on a resource corresponding to the initial container group and a resource corresponding to the virtual container group, the resource preoccupation unit is configured for:
updating a state of the scheduling interface object according to states of the initial container group and the virtual container group; and
correspondingly, the creating a new container group based on all preoccupied resources of the scheduling interface object includes:
after it is detected that the state of the scheduling interface object is an available state, creating the new container group based on all the preoccupied resources of the scheduling interface object.

According to at least one embodiment of the present disclosure, upon updating a state of the scheduling interface object according to states of the initial container group and the virtual container group, the resource preoccupation unit is configured for:
adding the resource corresponding to the virtual container group to preoccupied resources managed by the scheduling interface object for preoccupation, and updating the state of the scheduling interface object to a waiting state after the initial container group is associated with the scheduling interface object; and
after the resource corresponding to the initial container group as recycled is added to the preoccupied resources managed by the scheduling interface object for preoccupation, updating the state of the scheduling interface object to the available state.

According to at least one embodiment of the present disclosure, upon updating a state of the scheduling interface object according to states of the initial container group and the virtual container group, the resource preoccupation unit is configured for:
when the virtual container group is created on the resource node, if the virtual container group is not successfully created, updating the state of the scheduling interface object to a pending state, and performing one or more retries within a preset time; and
if the virtual container group is not successfully created within the preset time, updating the state of the scheduling interface object to a failure state.

According to at least one embodiment of the present disclosure, after the associating the initial container group with the scheduling interface object, the resource preoccupation unit is configured for:
adding a deletion interceptor to the initial container group; and
correspondingly, the adding the resource corresponding to the initial container group as recycled to the preoccupied resources managed by the scheduling interface object for preoccupation after the resource corresponding to the initial container group is recycled includes:
after it is detected that the initial container group exits, adding the resource corresponding to the initial container group to the preoccupied resources managed by the scheduling interface object; and
removing the deletion interceptor from the initial container group, and recycling the resource corresponding to the initial container group, to complete preoccupation of the resource corresponding to the initial container group as recycled by the scheduling interface object.

According to at least one embodiment of the present disclosure, upon adding the resource corresponding to the virtual container group to preoccupied resources managed by the scheduling interface object for preoccupation, the resource preoccupation unit is configured for:
modifying preoccupied resource information in configuration information of the scheduling interface object as resource information of the resource corresponding to the virtual container group;
upon associating the initial container group with the scheduling interface object, the resource preoccupation unit is configured for:
modifying, in configuration information of the scheduling interface object, to-be-recycled resource information as resource information of the resource corresponding to the initial container group; and
upon adding the resource corresponding to the initial container group to the preoccupied resources managed by the scheduling interface object after detecting that the initial container group exits, the resource preoccupation unit is configured for:
adding, in the configuration information of the scheduling interface object, the resource information that is of the resource corresponding to the initial container group and that is in the to-be-recycled resource information to the preoccupied resource information, and clearing the to-be-recycled information.

According to at least one embodiment of the present disclosure, the resource preoccupation unit is configured for: if it is determined that the resource capacity adjustment instruction is a resource capacity reduction instruction, controlling the scheduling interface object to perform preoccupation on the resource corresponding to the initial container group;
the resource preoccupation unit is further configured for creating the new container group based on all the preoccupied resources of the scheduling interface object.

According to at least one embodiment of the present disclosure, upon controlling the scheduling interface object to perform preoccupation on the resource corresponding to the initial container group, the resource preoccupation unit is configured for:
associating the initial container group with the scheduling interface object, and after the resource corresponding to the initial container group is recycled, adding the resource corresponding to the initial container group as recycled to the preoccupied resources managed by the scheduling interface object for preoccupation.

According to at least one embodiment of the present disclosure, upon controlling the scheduling interface object to perform preoccupation on the resource corresponding to the initial container group, the resource preoccupation unit is further configured for:
updating a state of the scheduling interface object according to a state of the initial container group; and
correspondingly, the container group creating unit creates the new container group based on all the preoccupied resources of the scheduling interface object includes:
after it is detected that the state of the scheduling interface object is an available state, creating the new container group based on all the preoccupied resources of the scheduling interface object.

According to at least one embodiment of the present disclosure, upon updating a state of the scheduling interface object according to a state of the initial container group, the resource preoccupation unit is configured for:
after the initial container group is associated with the scheduling interface object, updating the state of the scheduling interface object to a waiting state; and
after the resource corresponding to the initial container group as recycled is added to the preoccupied resources managed by the scheduling interface object for preoccupation, updating the state of the scheduling interface object to the available state.

According to at least one embodiment of the present disclosure, after the associating the initial container group with the scheduling interface object, the resource preoccupation unit is further configured for:
adding a deletion interceptor to the initial container group; and
correspondingly, the adding the resource corresponding to the initial container group as recycled to the preoccupied resources managed by the scheduling interface object for preoccupation after the resource corresponding to the initial container group is recycled includes:
after it is detected that the initial container group exits, adding the resource corresponding to the initial container group to the preoccupied resources managed by the scheduling interface object; and
removing the deletion interceptor from the initial container group, and recycling the resource corresponding to the initial container group, to complete preoccupation of the resource corresponding to the initial container group as recycled by the scheduling interface object.

According to at least one embodiment of the present disclosure, upon associating the initial container group with the scheduling interface object, the resource preoccupation unit is configured for:
modifying, in configuration information of the scheduling interface object, to-be-recycled resource information as resource information of the resource corresponding to the initial container group; and
upon adding the resource corresponding to the initial container group to the preoccupied resources managed by the scheduling interface object after detecting that the initial container group exits, the resource preoccupation unit is configured for:
adding, in the configuration information of the scheduling interface object, the resource information that is of the resource corresponding to the initial container group and that is in the to-be-recycled resource information to the preoccupied resource information, and clearing the to-be-recycled information.

According to a third aspect, at least one embodiment of the present disclosure provides an electronic device, which includes:
at least one processor; and
a non-transitory memory with instructions thereon,
wherein upon the instructions being executed by the processor, the processor is configured for:
creating a scheduling interface object for performing resource preoccupation in response to a resource capacity adjustment instruction for an initial container group that has been created on a resource node, wherein the resource capacity adjustment instruction includes target resource capacity after adjustment;
if it is determined that the resource capacity adjustment instruction is a resource capacity expansion instruction, creating a virtual container group on the resource node according to a capacity difference between the target resource capacity and an initial resource capacity of the initial container group; and
controlling the scheduling interface object to perform preoccupation on a resource corresponding to the initial container group and a resource corresponding to the virtual container group, and creating a new container group based on all preoccupied resources of the scheduling interface object.

According to at least one embodiment of the present disclosure, the controlling the scheduling interface object to perform preoccupation on a resource corresponding to the initial container group and a resource corresponding to the virtual container group includes:
adding the resource corresponding to the virtual container group to preoccupied resources managed by the scheduling interface object for preoccupation; and
associating the initial container group with the scheduling interface object, and after the resource corresponding to the initial container group is recycled, adding the resource corresponding to the initial container group as recycled to the preoccupied resources managed by the scheduling interface object for preoccupation.

According to at least one embodiment of the present disclosure, upon the instructions being executed by the processor, the processor is further configured for:
updating a state of the scheduling interface object according to states of the initial container group and the virtual container group; and
correspondingly, the creating a new container group based on all preoccupied resources of the scheduling interface object includes:
after it is detected that the state of the scheduling interface object is an available state, creating the new container group based on all the preoccupied resources of the scheduling interface object.

According to at least one embodiment of the present disclosure, the updating a state of the scheduling interface object according to states of the initial container group and the virtual container group includes:
adding the resource corresponding to the virtual container group to preoccupied resources managed by the scheduling interface object for preoccupation, and updating the state of the scheduling interface object to a waiting state after the initial container group is associated with the scheduling interface object; and
after the resource corresponding to the initial container group as recycled is added to the preoccupied resources managed by the scheduling interface object for preoccupation, updating the state of the scheduling interface object to the available state.

According to at least one embodiment of the present disclosure, the updating a state of the scheduling interface object according to states of the initial container group and the virtual container group includes:
when the virtual container group is created on the resource node, if the virtual container group is not successfully created, updating the state of the scheduling interface object to a pending state, and performing one or more retries within a preset time; and
if the virtual container group is not successfully created within the preset time, updating the state of the scheduling interface object to a failure state.

According to at least one embodiment of the present disclosure, the adding the resource corresponding to the virtual container group to preoccupied resources managed by the scheduling interface object for preoccupation includes:
modifying preoccupied resource information in configuration information of the scheduling interface object as resource information of the resource corresponding to the virtual container group.

According to at least one embodiment of the present disclosure, upon the instructions being executed by the processor, the processor is further configured for:
if it is determined that the resource capacity adjustment instruction is a resource capacity reduction instruction, controlling the scheduling interface object to perform preoccupation on the resource corresponding to the initial container group, and creating the new container group based on all the preoccupied resources of the scheduling interface object.

According to a fourth aspect, at least one embodiment of the present disclosure further provides a computer-readable storage medium, wherein the computer-readable storage medium stores computer-executable instructions, and upon a processor executing the computer-executable instructions, the resources scheduling method according to the first aspect and all possible designs of the first aspect is implemented.

According to a fifth aspect, at least one embodiment of the present disclosure provides a computer program product, including computer-executable instructions, wherein when a processor executes the computer-executable instructions, the resources scheduling method according to the first aspect and all possible designs of the first aspect is implemented.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and acts described above are only exemplary forms of implementing the claims.

1. A resource scheduling method, comprising:
creating a scheduling interface object for performing resource preoccupation in response to a resource capacity adjustment instruction for an initial container group that has been created on a resource node, wherein the resource capacity adjustment instruction comprises target resource capacity after adjustment;
if it is determined that the resource capacity adjustment instruction is a resource capacity expansion instruction, creating a virtual container group on the resource node according to a capacity difference between the target resource capacity and an initial resource capacity of the initial container group; and
controlling the scheduling interface object to perform preoccupation on a resource corresponding to the initial container group and a resource corresponding to the virtual container group, and creating a new container group based on all preoccupied resources of the scheduling interface object.

2. The method according to claim 1, wherein the controlling the scheduling interface object to perform preoccupation on a resource corresponding to the initial container group and a resource corresponding to the virtual container group comprises:
adding the resource corresponding to the virtual container group to preoccupied resources managed by the scheduling interface object for preoccupation; and
associating the initial container group with the scheduling interface object, and after the resource corresponding to the initial container group is recycled, adding the resource corresponding to the initial container group as recycled to the preoccupied resources managed by the scheduling interface object for preoccupation.

3. The method according to claim 2, wherein the method further comprises:
updating a state of the scheduling interface object according to states of the initial container group and the virtual container group; and
correspondingly, the creating a new container group based on all preoccupied resources of the scheduling interface object comprises:
after it is detected that the state of the scheduling interface object is an available state, creating the new container group based on all the preoccupied resources of the scheduling interface object.

4. The method according to claim 3, wherein the updating a state of the scheduling interface object according to states of the initial container group and the virtual container group comprises:
adding the resource corresponding to the virtual container group to preoccupied resources managed by the scheduling interface object for preoccupation, and updating the state of the scheduling interface object to a waiting state after the initial container group is associated with the scheduling interface object; and
after the resource corresponding to the initial container group as recycled is added to the preoccupied resources managed by the scheduling interface object for preoccupation, updating the state of the scheduling interface object to the available state.

5. The method according to claim 3, wherein the updating a state of the scheduling interface object according to states of the initial container group and the virtual container group comprises:
when the virtual container group is created on the resource node, if the virtual container group is not successfully created, updating the state of the scheduling interface object to a pending state, and performing one or more retries within a preset time; and
if the virtual container group is not successfully created within the preset time, updating the state of the scheduling interface object to a failure state.

6. The method according to claim 2, wherein the adding the resource corresponding to the virtual container group to preoccupied resources managed by the scheduling interface object for preoccupation comprises:
modifying preoccupied resource information in configuration information of the scheduling interface object as resource information of the resource corresponding to the virtual container group.

7. The method according to claim 1, wherein the method further comprises:
if it is determined that the resource capacity adjustment instruction is a resource capacity reduction instruction, controlling the scheduling interface object to perform preoccupation on the resource corresponding to the initial container group, and creating the new container group based on all the preoccupied resources of the scheduling interface object.

8. The method according to claim 7, wherein the controlling the scheduling interface object to perform preoccupation on the resource corresponding to the initial container group comprises:
associating the initial container group with the scheduling interface object, and after the resource corresponding to the initial container group is recycled, adding the resource corresponding to the initial container group as recycled to the preoccupied resources managed by the scheduling interface object for preoccupation.

9. The method according to claim 8, wherein the controlling the scheduling interface object to perform preoccupation on the resource corresponding to the initial container group further comprises:
updating a state of the scheduling interface object according to a state of the initial container group; and
correspondingly, the creating the new container group based on all the preoccupied resources of the scheduling interface object comprises:
after it is detected that the state of the scheduling interface object is an available state, creating the new container group based on all the preoccupied resources of the scheduling interface object.

10. The method according to claim 9, wherein the updating a state of the scheduling interface object according to a state of the initial container group comprises:
after the initial container group is associated with the scheduling interface object, updating the state of the scheduling interface object to a waiting state; and
after the resource corresponding to the initial container group as recycled is added to the preoccupied resources managed by the scheduling interface object for preoccupation, updating the state of the scheduling interface object to the available state.

11. The method according to claim 2, wherein after the associating the initial container group with the scheduling interface object, the method further comprises:
adding a deletion interceptor to the initial container group; and
correspondingly, the adding the resource corresponding to the initial container group as recycled to the preoccupied resources managed by the scheduling interface object for preoccupation after the resource corresponding to the initial container group is recycled comprises:
after it is detected that the initial container group exits, adding the resource corresponding to the initial container group to the preoccupied resources managed by the scheduling interface object; and
removing the deletion interceptor from the initial container group, and recycling the resource corresponding to the initial container group, to complete preoccupation of the resource corresponding to the initial container group as recycled by the scheduling interface object.

12. The method according to claim 11, wherein the associating the initial container group with the scheduling interface object comprises:
modifying, in configuration information of the scheduling interface object, to-be-recycled resource information as resource information of the resource corresponding to the initial container group; and
the adding the resource corresponding to the initial container group to the preoccupied resources managed by the scheduling interface object after it is detected that the initial container group exits comprises:
adding, in the configuration information of the scheduling interface object, the resource information that is of the resource corresponding to the initial container group and that is in the to-be-recycled resource information to the preoccupied resource information, and clearing the to-be-recycled information.

13. An electronic device, comprising:
at least one processor; and
a non-transitory memory with instructions thereon,
wherein upon the instructions being executed by the processor, the processor is configured for:
creating a scheduling interface object for performing resource preoccupation in response to a resource capacity adjustment instruction for an initial container group that has been created on a resource node, wherein the resource capacity adjustment instruction comprises target resource capacity after adjustment;
if it is determined that the resource capacity adjustment instruction is a resource capacity expansion instruction, creating a virtual container group on the resource node according to a capacity difference between the target resource capacity and an initial resource capacity of the initial container group; and
controlling the scheduling interface object to perform preoccupation on a resource corresponding to the initial container group and a resource corresponding to the virtual container group, and creating a new container group based on all preoccupied resources of the scheduling interface object.

14. The electronic device according to claim 13, wherein the controlling the scheduling interface object to perform preoccupation on a resource corresponding to the initial container group and a resource corresponding to the virtual container group comprises:
adding the resource corresponding to the virtual container group to preoccupied resources managed by the scheduling interface object for preoccupation; and
associating the initial container group with the scheduling interface object, and after the resource corresponding to the initial container group is recycled, adding the resource corresponding to the initial container group as recycled to the preoccupied resources managed by the scheduling interface object for preoccupation.

15. The electronic device according to claim 14, wherein upon the instructions being executed by the processor, the processor is further configured for:
updating a state of the scheduling interface object according to states of the initial container group and the virtual container group; and
correspondingly, the creating a new container group based on all preoccupied resources of the scheduling interface object comprises:
after it is detected that the state of the scheduling interface object is an available state, creating the new container group based on all the preoccupied resources of the scheduling interface object.

16. The electronic device according to claim 15, wherein the updating a state of the scheduling interface object according to states of the initial container group and the virtual container group comprises:
adding the resource corresponding to the virtual container group to preoccupied resources managed by the scheduling interface object for preoccupation, and updating the state of the scheduling interface object to a waiting state after the initial container group is associated with the scheduling interface object; and
after the resource corresponding to the initial container group as recycled is added to the preoccupied resources managed by the scheduling interface object for preoccupation, updating the state of the scheduling interface object to the available state.

17. The electronic device according to claim 15, wherein the updating a state of the scheduling interface object according to states of the initial container group and the virtual container group comprises:
when the virtual container group is created on the resource node, if the virtual container group is not successfully created, updating the state of the scheduling interface object to a pending state, and performing one or more retries within a preset time; and
if the virtual container group is not successfully created within the preset time, updating the state of the scheduling interface object to a failure state.

18. The electronic device according to claim 14, wherein the adding the resource corresponding to the virtual container group to preoccupied resources managed by the scheduling interface object for preoccupation comprises:
modifying preoccupied resource information in configuration information of the scheduling interface object as resource information of the resource corresponding to the virtual container group.

19. The electronic device according to claim 14, wherein upon the instructions being executed by the processor, the processor is further configured for:
if it is determined that the resource capacity adjustment instruction is a resource capacity reduction instruction, controlling the scheduling interface object to perform preoccupation on the resource corresponding to the initial container group, and creating the new container group based on all the preoccupied resources of the scheduling interface object.

20. A computer-readable storage medium, wherein the computer-readable storage medium stores computer-executable instructions, and upon a processor executing the computer-executable instructions, the method according to claim 1 is implemented.
